(19) United States
(12) Patent Application Publication
(10) Pub. No.: US 2013/0018882 A1
(43) Pub. Date: Jan. 17, 2013

(54) Method and System for Sharing Life Experience Information

(71) Applicant: Brad Martin Listermann, Palm Springs, CA (US)

(72) Inventor: Brad Martin Listermann, Palm Springs, CA (US)

(21) Appl. No.: 13/269,588

(22) Filed: Oct. 8, 2011

Related U.S. Application Data
(60) Provisional application No. 61/507,584, filed on Jul. 13, 2011.

(51) Int. Cl. G06F 17/30; G06F 15/16

(52) U.S. Cl. 707/736; 709/203; 707/E17.005

(57) ABSTRACT

A computer-implemented method and system comprise a server executing a computer-executable program being configured for receiving psychological profiling information, life experience information and tags at least comprising date information, comments and emotions for the life experience information from registered members of a life experience system. The server is further configured for processing the psychological profiling information, life experience information and tags to generate a psychological profile of the member and a timeline of the life experience information. A client executing a computer-executable application is configured for submitting the psychological profiling information, life experience information and tags to the server. The client is further configured for receiving from the server a home page in which the time line and the life experience information is accessible.

### CROSS-REFERENCE TO RELATED APPLICATIONS

The present Utility patent application claims priority benefit of the U.S. provisional application for patent Ser. No. 61/507,584 filed on Jul. 13, 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to social systems. More particularly, the invention relates to the invention relates to life experience systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Social networking systems enable users to connect with one another by sharing information such as videos, pictures and other information. Via social networking systems, users may communicate and collaborate in order to share information. These systems enable users to remain in contact with one another and provide information associated with the user's activities.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example system, in accordance with an embodiment of the present invention;

FIG. 2 illustrates an example presentation, in accordance with an embodiment of the present invention;

FIG. 3A illustrates an example presentation, in accordance with an embodiment of the present invention;

FIG. 3B continues the illustration of example presentation discussed with reference to FIG. 3A, in accordance with an embodiment of the present invention;

FIG. 4 illustrates an example chart, in accordance with an embodiment of the present invention;

FIGS. 5A-B illustrates an example presentation, in accordance with an embodiment of the present invention;

FIG. 6 is a block diagram depicting an exemplary client/server system which may be used by an exemplary web-enabled/networked embodiment of the present invention;

FIG. 7 illustrates an example method for account setup and configuration, in accordance with an embodiment of the present invention;

FIG. 8 illustrates an example method for account setup and configuration, in accordance with an embodiment of the present invention;

FIG. 9 illustrates a computing system that, when appropriately configured or designed, may serve as a computing system for which the present invention may be embodied; and

FIG. 10 illustrates an example interface for a mobile device, in accordance with an embodiment of the present invention.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention will be described which provides means and methods for providing a system for storing, retrieving and processing information associated with life experiences. System provides capability to receive and process stimuli and responses in order to create a model of a person. The created model of the person provides capability to present a representation of a person's responses with regard to receiving stimuli. System provides capability for viewing and interacting with information associated with a person's life experiences. System provides psychological profiling that helps assist in finding out who the person is and what's most important to the person, so that a custom video trailer and profile can be created. System provides automatic processing of items on the person's profile into a produced video, “My Life” video. System helps the person build a system generated and automatic updated video of his/her life. Also, system can do a short “Life Trailer”. System provides scanning capabilities for scanning and organizing personal items like, but not limited to, greetings cards, letters, certificates, pictures etc. System provides for tagging and labeling them for the online system storage into LifePage. System enables voice command searching and navigating the person's timeline.

During tagging of digital information placed into the system, the system may ask questions such as “Who, where, what etc.” Additionally, the system may ask members to describe a feeling or sentiment from a drop down menu. Members may also choose to use icons like happy, sad or mad faces. When members associate as much sentiment and feeling as possible, a richer, better experiences may be provided when people search for certain items. Psychological profiling may also prompt further questions unique to the user that can assist in properly tagging and storing the information for later uses. When the system identifies “holes” or missing information, it may prompt questions and suggestions that will help the user to fill in the areas. If data or items or missing, the system may prompt for a video memory to be taped online or a written note or journal describing the memory to assist for a fuller life collection.

With the system ability to tag “thoughts”, “feelings” and “emotions”, they may be brought up in searches. Also, with the profiling, the system may start to customize the experience for each user.

User members of don't have to worry about others tagging them without permission. For initial new members items are kept private and secure by default, with no tagging allowed, until the member decides to allow certain people to tag them, comment etc. System is private by design and simple if members wish to add others to access their page and information.

Systems monitor quality of items uploaded such as, but not limited to, pictures, scanned items and videos to ensure a level of quality. Systems use the latest in photo and video up scaling to assist with better quality. When members quality of uploads is not enough, they will be prompted and asked for a better item and offered suggestions on getting or making better quality if one does not exist.

System enables members to change the “LifePage”, front page of their interface to represent a personal scrap book. System may ask questions such as, but not limited to, What design would you like?, Who are the most important people to you?, What music, color and other personal tastes could you present in your LifePage?, etc. System may offer many choices in design, colors and psychological representations of the member such, but not limited to, as Avatars or a collage of their favorite memories. If the member is not creative, the system may offer choices based on their psychological profile. System may also offer simple LifeLine graph with the least clutter for members that wish for a clean, simple, uncluttered experience.

System provides privacy design and assurances to be clear, easy to use simple buttons and with no hidden legal language causing member privacy to be at risk. Members choose who can see their LifePage, then set it and forget it. Member privacy is assured through the most rigid standards.

System provides instructional videos of how to make a member's LifePage. Using information from a member's psychological profiling and questionnaires, the system may suggest items including, but not limited to, making videos as journals for thoughts and memories of certain events when there is no item to store. Videos may be used for past items, or, for future events as well such as, but not limited to, advice for a loved one. Members may be encouraged to scan and upload items such as, but not limited to, notes, letters and documents that are a vital part of their life. Services may be offered for people who need assistance such as, but not limited to, scanning, digital transfer etc., to help the non digital world move its life items onto the LifePage system. In a non-limiting example, these services may be at a center or through, upload and mail in services.

System may use members' psychological profiles in numerous ways. In non-limiting examples, profiles may be used for creating custom views and profiles, recommending friends and potential new associations, assisting with making dating matches and love connections through suggested connections and recommended associations, assisting business connection in better understanding of the person a member wishes to do business with. In other non-limiting examples, profiles may be used for making suggestions that might assist the member, including reminders about close personal relationships, reminders of missing past information and suggestions to help tag or label items for a better connecting experience. In other non-limiting examples, psychological profiles may also be used for grouping personality types for interests, clubs and other associations, suggestions for advertising, suggestions for joining clubs, activities and media, email reminders and daily tips. In other non-limiting examples, Self help, life coaches and other motivational speakers can target users, tips, philosophy, quotes, short lessons, inspirational items, spiritual messages etc., may be targeted and provided to members.

The more detailed profiles are created, the better the system may serve the member. In a non-limiting example, if the system knows that a member has identified key people as their most important relationships, the system may ask specific questions related to events to assist in tagging. This information may be greatly useful for when the “person of importance” is searching and the results show the various memories that the member had tagged that person was missing and how they felt. System isn't only about show and tell about what a person has in photos. Detailed profiling helps fill in gaps of lives and show important “feelings, sentiments and associations” not normally reflected in photos or other tagged items.

The detailed psychological profiling, such as “most important people” and “most important memories” may be collected in both early entry sign up points to members as well as in continued uploaded storage of life items. In a non-limiting example, there may be buttons and drop down menus allowing to “Star” or “Key” symbol for key life moments. Then this information would be crossed with “Most important memories or persons” to ask key questions to help “fill in” and enrich the experience of the member.

Members may also build a LifePage for loved ones, for lost loved ones or people of interest. In other words, the use of an in depth profiling may be provided by family or loved ones to create a profile for a person deceased or unable to provide a profile. In depth questions and profiling may assist the member is filling up the profile of the person of interest. Non-limiting examples include, “What were your favorite memories of this person?”, “What are the biggest moments in the person's life? “How did you feel about them during certain period in their life?”

System may use intelligence in all areas of profiling. That begins with the way new members are brought in and how they are continued to profiled later on. In a non-limiting example, the system may use intelligence to respond to members that do not like to be asked such in depth questions by allowing the members to rank the question with “like and dislike”. The more they “like” in depth profiling, the more the system will ask. For members that “dislike” certain types of questions and profiling, the system may adjust the level of questioning to lighten the approach and try and find alternative ways to fill out the profile more fully. This way, the system is more user friendly and adapts the profiling to the members tastes. On initial sign up, the use of psychological test questions may be used to determine the new member's willingness to answer personal questions. The questions will then be adjusted to fit the personality type more comfortably. Each member signing up will have their own individual experience. This is not only in the profiling, but in how the system makes suggestions, makes recommendations', ask questions, pushes advertising or products, connects and suggests people etc. System may use constant feedback buttons and intelligence to better determine the members experience and tailor the experience to match their psychological profile and tastes combined. Each member will have unique experiences in all aspects of their LifePage based on intelligence from tastes, psychological profiling and other data gathering. That may even include the look and feel of the LifePage. In a non-limiting example, people a member has shown are most important and profiling has revealed key elements of relationship depth, these individuals may be featured on the member's “Home LifePage” and the interface may be changed to create a feeling of better contentment with the members experience and life. If the member has shown in the psychological profiling to use LifePage as a reminder of happy memories, those memories and such influences may be prominently posted and featured in unique ways allowing the member to have the best of times reflected in all areas of their LifePage experience. In another non-limiting example, a member's personality tests and tastes have shown a dislike for reminders, flashiness and “clutter”. This member may have a clean, simple LifePage with a Lifeline that uses almost no pictures or “thumbs” unless clicked upon for viewing. Likewise, recommendations and ads may be also carefully crafted to fit the profile of this member.

In another non-limiting example, some members may wish to see a collage of their favorite moments presented whenever they log in or the video of their life to play. All of these customized settings may be set by user or the intelligence of the system may make the suggestions and features available automatically.

For “Live Forever” as well as for normal members; video journals, voice journals (recorded voice tapings) and written journals or notes may be strongly encouraged throughout their LifeLine, their lives. It is like a voice over to help narrate their lives and create far more insight into the user's life, thoughts feelings and insight.

System may use voice to text technology to transcribe voice and create profiles of most used key words in voice and videos etc. System may use that information as part of the psychological profiling done.

System may also use voice technology in apps and on the system, including tablets, smart phones etc, to allow the user to navigate through the LifePage experience with voice only commands.

In some embodiments, a service includes a computerized system at store/retail locations, or, through in home services that help new members to move their stored life items such as, but not limited to, photos, notes, greeting cards, love letters etc. into the system. Many users will either be uncomfortable with technology such as scanning and may desire the service of assistance in moving non digital items into the digital works. This assistance is crucial in helping the people who are non digital move their lives online; creating a much safer and long lasting place for these important records and items.

In some embodiments, Memory Centers may be offered at locations such as, but not limited to, malls, funeral homes or retail centers. These centers may have scan and upload assistance, Live Forever Packages, video production capabilities and Memory Rooms where you may have a large screen, rich multimedia experience of the person you wish to visit, or to share LifePage experience with others.

Each member of LifePage may be provided with interesting facts or suggestions about their life or “Rhythm's Of Your Life”. In a non-limiting example, the system may send members a message letting them know that certain information on their LifePage is missing and can offer suggestions for things they should include about their life. Additionally, it will notify them about interesting facts about their life. In a non-limiting example, on a moment they have marked as important life events, it may notify them of other historical facts about that date. In a non-limiting example, the system may use the tagging and labeling intelligence to match the information that may be important to that person and present it to them. In a non-limiting example, the LifePage owner mentioned it was raining today, and historical facts match that on this date in history, it hasn't rained since 1914.

In some embodiments, using the search criteria, a user may enter in a particular subject of their life and that information may be presented in a dynamic lifeline separate from their usual lifeline presenting just the information they asked about. In a non-limiting example, a mother wants to know what year she had more posts on her kids? Or when did she spend more time with her kids at activities and what days was she most busy running to these activities?

In another embodiment part of LifePage may be income and career information. Part of the LifePage profiling may be the member's income and career information. In a non-limiting example, questions that may be asked are What years were you most successful? When did you make the most money? Maybe you want to know what days of the year you were most successful—when did you win the most awards or perform best a certain times of the year?

“Rhythms Of Your Life” is a means for members to ask important questions about their life and learn more about them. In a non-limiting example, the member may have the ability to target specific months, days and seasons. If the system is lacking information it may prompt the member to “examine your life and find out things we don't necessarily see on the surface because we are caught up in our day to day routines”.

In some embodiments the system may present chart that may be rhythmic and dynamic.

In some embodiments members may use facts about their life to analyze, without limitation, their lives, careers etc. With the systems extensive psychological profiling, the system may provide suggestions to help improve their life. This may depend on user settings and intelligences. System may provide life coaching or suggestions for betterment. System may provide, without limitation inspirational quotes, suggested links, articles, books and other educational materials, websites etc.

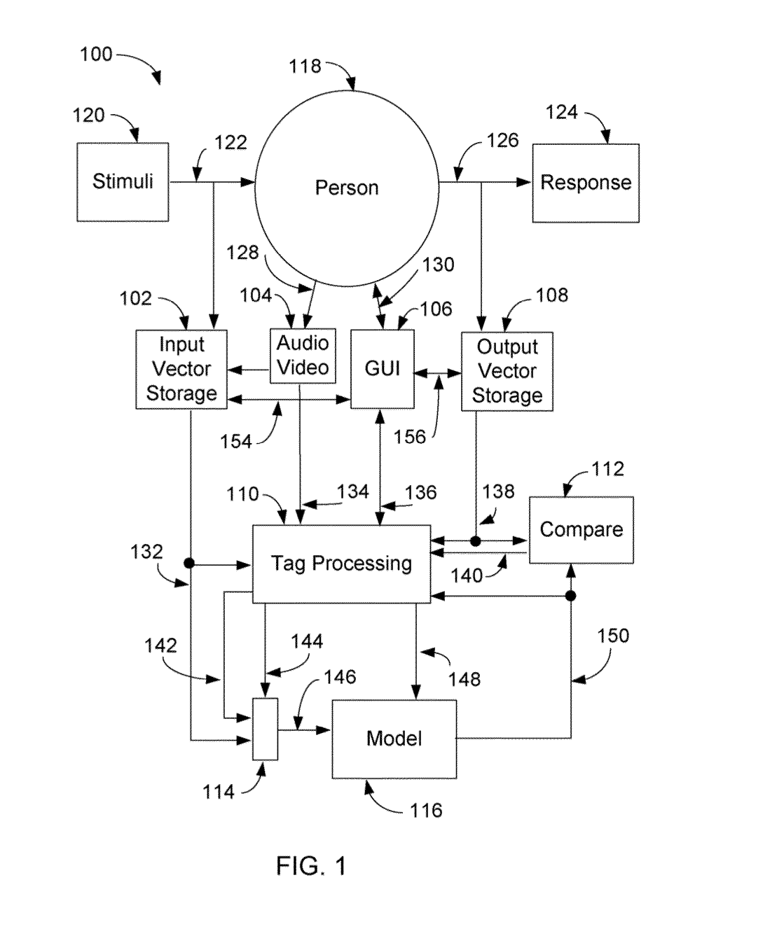

FIG. 1 illustrates an example system, in accordance with an embodiment of the present invention.

A system 100 includes an input vector storage portion 102, an audio/video portion 104, a Graphical User Interface (GUI) 106, an output vector storage portion 108, a tag processing portion 110, a compare portion 112, a multiplexer portion 114 and a model portion 116.

A person 118 and input vector storage portion 102 are arranged to receive input stimuli information from a stimuli portion 120 via a communication channel 122.

A response 124 and output vector storage portion 108 are arranged to receive output responses from person 118 via a communication channel 126.

Audio/video portion 104 receives audio and video information from person 118 via a communication channel 128.

GUI 106 communicates bi-directionally with person 118 via a communication avenue 130.

Tag processing portion 110 and multiplexer portion 114 receive information from input vector storage portion 102 via a communication channel 132.

Tag processing portion 110 receives information from audio/video portion 104 via a communication channel 134.

Tag processing portion 110 communicates bi-directionally with GUI 106 via a communication channel 136.

Tag processing portion 110 and compare portion 112 receive information from output vector storage portion 108 via a communication channel 138.

Tag processing portion 110 receives information from compare portion 112 via a communication channel 140.

Multiplexer portion 114 receives information from tag processing portion 110 via a communication channel 142.

Multiplexer portion 114 receives a control signal 144 from tag processing portion 110.

Model portion 116 receives information from multiplexer portion 114 via a communication channel 146.

Model portion 116 receives information from tag processing portion 110 via a communication channel 148.

Tag processing portion 110 and compare portion 112 receive information from model portion 116 via a communication channel 150.

GUI 106 communicates with input vector storage portion 102 via a communication channel 154.

GUI 106 communicates bi-directionally with output vector storage portion 108 via a communication channel 156.

Input vector storage portion 102 stores information associated with input presentation. As a non-limiting example, information stored via input vector storage portion 102 includes web pages visited. For example, a user may visit an online forum and read information associated with a query for information with the user entering a response to the query. The information associated with the online forum viewed by the user may be stored in input vector storage portion 102.

Audio/video portion 104 captures and stores received audio/video. As an example, a user may capture audio/video associated with answering a question associated with an online forum query.

GUI 106 provides an interface mechanism for a user. For example, a user may enter textual information via GUI 106. Furthermore, as another example, a user may view a website and/or video information or listen to audio information.

Output vector storage portion 108 stores information associated with output responses provided by a user in response to received presentation. For example, a response provided to an online forum by a user may be stored in output vector storage portion 108.

Tag processing portion 110 receives stored input presentation, input audio/video and associated output responses for determination of parameters, architecture, etc. associated with a model for modeling the responses of a person. For example, a response to a query for an online joke form may be tagged or associated as a joke or humor. The system may automatically generate questions to help the user with tagging. Such as, without limitation, “who was there?” “Please associate a feeling or sentiment about this” etc. with possible drop down choices.

Compare portion 112 compares the output results of a model with prior actual responses for determining the accuracy of the model. For example, compare portion 112 may compare the prior response of a user with the response of a model to determine if the model accurately models the behavior of a user.

Multiplexer provides selection between two information inputs in order for the selected information to be provided at is output.

Model portion 116 provides a model of a person based upon the response to prior presentation. For example, based upon past responses to presentation and other information, model portion 116 may operate to predict how a person would respond based upon a given stimulus.

In operation, presentations received by person 118 via communication channel 122 are recorded via input vector storage portion 102. Furthermore, responses provided by person 118 via communication channel 126 are recorded by output vector storage portion 108. Furthermore, audio/video information provided by person 118 via communication channel 128 is stored via audio/video portion 104. Furthermore, person 118 interfaces with GUI 106 via communication avenue 130. Furthermore, tag processing portion 110 receives information from input vector storage portion 102, audio/video portion 104, GUI 106 and output vector storage portion 108 for developing an operation model for person 118. As a non-limiting example, the model developed by tag processing portion 110 may be a neural network. Tag processing portion 110 provides the developed model to model portion 116 via communication channel 148. Furthermore, tag processing portion 110 may test the accuracy of model portion 116 by selecting multiplexer portion 114 to select prior presentation stored in input vector storage portion 102 via communication channel 132 and performing a comparison via compare portion 112 of the prior results provided by output vector storage portion 108 via communication channel 138 and the predicted output results provided from model portion 116 via communication channel 150. Furthermore, based upon the testing performed, tag processing portion 110 may modify the parameters and architecture for model portion 116 via communication channel 148.

FIG. 1 illustrates an example system for developing a model of a person based upon prior presentation and responses.

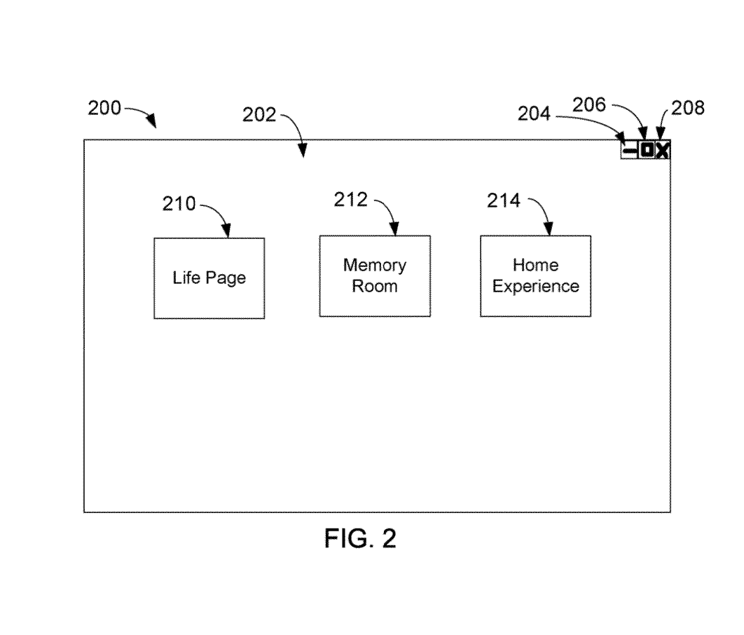

FIG. 2 illustrates an example presentation, in accordance with an embodiment of the present invention.

A presentation 200 includes a presentation area 202, a minimize button 204, a maximize button 206, a close button 208, a life page selection 210, a memory room selection 212 and a home experience selection 214.

Presentation 200 presents available selections for interacting with system 100. For example, person 118 (FIG. 1) may be presented with presentation 200 via a GUI.

Minimize button 204 enables minimization of presentation 200. For example selecting minimize button 204 removes presentation 200 from being displayed via the GUI, yet presentation 200 remains alive for later reactivation.

Maximize button 206 enables maximization of presentation 200. For example, selecting maximize button 206 enables the display of presentation 200 to occupy the display area associated with the GUI.

Close button 208 enables termination of display of presentation 200. For example, selecting close button 208 enables closing presentation 200 from being presented via the GUI.

Life page selection 210 enables interacting with a life page for receiving, uploading and presenting information associated with a person's life experiences.

Memory room selection 212 enables interacting with the system for configuring, controlling and interfacing with a memory room.

Home experience selection 214 enables interacting with the system for configuring controlling and interfacing with system 100 from a user's home environment.

System 100 (FIG. 1) receives and stores information associated with the actions and information presented to person 118 (FIG. 1). Furthermore, received information may be stored in input vector storage portion 102 (FIG. 1). Furthermore, information receipt and storage may be performed in a continuous manner or in a non-continuous manner. In some embodiments, additional selection may be included for, without limitation, medical history, military record, etc. Each selection may have a default privacy setting as private.

A search engine provides a user with the capability to search and review a person's information. Non-limiting examples of information provided include information associated with specific days, years, photos, posts, videos thought tags, emotions, beliefs or expressions from a multiplicity of records.

Users may enter search queries for accessing information. Non-limiting examples of information includes website posts, picture, audio and video. For example, a mother may seek to create an online scrapbook of photos taken on the first day of school and first day of camp for the mother's college-bound child. Furthermore, the photos tagged with as “first” when entered may be retrieved. Similarly, a photo, video or other digitally storable item may be tagged with sentimental or emotional tags such as “sad”, “happy” or “worried”. Furthermore, more complex words and phrases can be tagged such as “tradition”, “honor” or “things I find funny”. In another example, a same mother may tag a picture of the child's first day at camp. For example, emotions tagged may include, “Worried” and “Moments that Mattered”. Searches may provide a multitude of search query results presenting basic search protocols. Non-limiting examples for search query results include dates and names. Furthermore, search query results may include information such as feelings, moral beliefs, underlying sentiments poems, scanned notes, love letters, journals etc.

System 100 may be used for reconnecting people with an event. Furthermore, system 100 may inform family and friends of the inner feelings and thoughts associated with a person.

Keywords and answers to suggested questions may be chosen when photos and other items are uploaded by a person.

System 100 (FIG. 1) enables user with the capability to view photos and recorded messages associated with a person following the person's death or incapacitation. Videos can be viewed in the convenience of a home setting and/or in an associated business establishment.

Information associated with a deceased person may be stored in input vector storage portion 102 (FIG. 1). Non-limiting examples of information which may be stored include photos and videos.

System 100 (FIG. 1) enables organization and presentation of information associated with a person which may be configured based upon a set of parameters.

System 100 (FIG. 1) may provide information associated with a person for a time period following the person's death. Furthermore, archived information may be retrieved via the person's family members and other authorized associates.

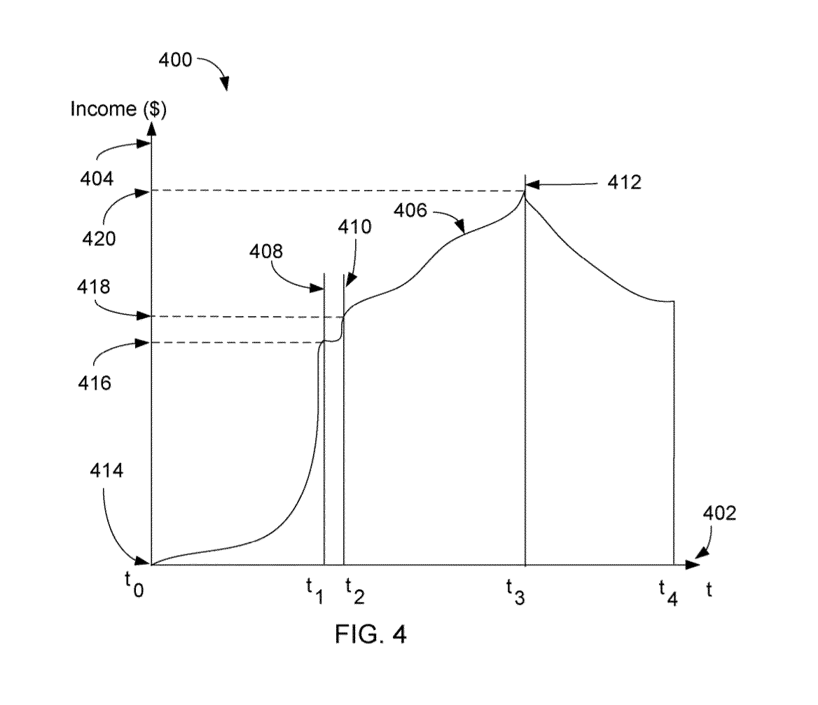

System 100 (FIG. 1) provides a visual interface for illustrating information associated with a person. Dynamic charts (e.g. FIG. 4) and other visual information may be provided for illustrating information associated with a person. Search engine and visual presentations may be integrated for providing graphical information associated with a person. As a non-limiting example, search engine enables users with the capability to review information associated with days, years, photos, posts, videos, apps., avatars etc.

System 100 (FIG. 1) provides a database which uses tags and/or labels for storing, organizing and disseminating information associated with a person's life. Non-limiting examples of processed information include digital media, blogs and journals.

System 100 (FIG. 1) provides a database for storing information which may be tagged or labeled with phrases. As a non-limiting example, a phrase used for tagging or labeling may include “thought tagging” and “emotional associations”. Furthermore, tags or labels associated with database organization system may be used for drop-down menus associated with a GUI.

Categories associated with received and stored information are configured for predicting elements of human social associations. Labels are selected in order to provide significance associated with historical information with respect to a person. For example, generalized tags/labels may be configured such as “Life Funny Moments” associated with real life events and are different from “Things I find Funny”, that not actual events. Non-limiting examples of actual events include jokes, videos, and clippings.

Labels and tags may be configured to cover aspects of the human experience such that when a user searches the database for a person, the search results depict the life experience(s) associated with the person. Furthermore, tags encompass human emotions and experiences with associated date and times of occurrence.

Information associated with database may be visually presented. Non-limiting examples for visual presentations include graphs and charts. Furthermore, charts and graphs may depict trends and events associated with a person's life experiences. GUI may use touch screen technology or any known interface technology for communicating with a user. Areas associated with a person's life may be selected via interface. Non-limiting examples of areas for selection include videos, tags, notes, digital media, scanned digital media, notes, records etc., and other tagged/labeled information.

Customized searches of the system may be performed for receiving information associated with a person's life. Non-limiting examples of search queries include “sense of humor 2011-2022” and “favorite quotes”. Search queries support inclusion of date information such as year, month, day, emotions and phrases etc. Search queries support inclusion of label and tag categorization information.

Information, including information developed via psychological testing, coaching and artificial intelligence may be combined with multimedia tools and information such as audio and video for modeling or predicting future behaviors and responses of a person on interest. As a non-limiting example, modeling or predicting future behaviors of a person enables interaction with a person. Furthermore, interaction may be performed after a person is deceased. System provides user with the capability to store information associated with their life and life experiences and for providing access to the stored information. Furthermore, stored information may be provided to social networks or other services for providing interaction of family, friends, etc. with a person's model.

Information stored and presented for a person may include information from the start of a person's life to the end of the person's life. Furthermore, a particular point of time or a particular period of time may be examined in detail. Furthermore, presented information may be modified or configured based upon a user's search query. As a non-limiting example, “funny moments” may be used as a search query for finding information about a person associated with humorous events in a person's life.

As an example, a search query for “funny moments” may return funny moments recorded and stored in the database. Non-limiting examples for sources of stored and retrieved information include journals, blogs, video, audio and scanned notes. Furthermore, “funny moments” query may present information via a chart or graph with dates and other information associated with the occurrence of the humorous events. Furthermore, the humorous moments may be categorized according to degrees of humor. Furthermore, presented humorous moments may be selected for viewing in further detail or for viewing an associated video or listening to an associated audio. Furthermore, system supports audio interaction with blind or visually impaired persons.

Information associated with a person's relationships may be stored, retrieved and presented for viewing. Furthermore, charts and graphs associated with the scope of a relationship may be presented for viewing. Non-limiting examples of information presented include time together and interesting moments. Non-limiting examples of for sources of information include audio, video, journals and blogs.

Information or notable items may be bookmarked for easy retrieval of the information by a user at a later date.

Presentation of information may be configured or customized in order to provide information in a user friendly and/or user pleasing manner. System provides an interactive presentation such that events associated with a particular day may be presented for viewing. Furthermore, the information associated with the selected day may be viewed with respect to tagged, labeled or categorized items. Presented information may be presented in a dynamic fashion based upon the interaction of a user. Furthermore, specific items may be presented in detail such as journals, notes or digital media.

Applications associated with the system may be provided via commercial centers. Commercial centers may include interfaces with touch screen technology, high resolution screens and high fidelity sound technology for providing a user with access to a dynamic presentation associated with a user's life experience(s). For example, via the system, a daughter may seek to experience a deceased father's life experience(s) and interact with the father's life experience model. Furthermore, the daughter may view charts associated with the father's life experiences. Furthermore, the daughter may view the father's personal blogs, journals and other items of interest. Furthermore, the daughter may view videos and listen to audio associated with the father. Non-limiting examples for viewed information include childhood videos and messages recorded by the father. Furthermore, an audio, video or slide show with an audio overlay generated by the father may be presented to the daughter on special occasions, birthday, anniversaries, holidays, etc. Furthermore, the presentation may include recorded information associated with the father's love and admiration for his daughter. Furthermore, as a result of the interaction with the system, the daughter may feel reconnected with the father.

System may query a user for items for used for initialization. Non-limiting examples for initialization items include scanned personal letters, notes and pictures. System supports receipt of information via scanning devices. Additional non-limiting examples of information requested for initialization include digital media such as audio, video and pictures. System categorizes and tags information received via interactive interface. Furthermore, GUI uses dynamic charts and graphs for providing detailed categorizations of received items. Furthermore, received information may be tagged or labeled by user thereby providing a personalized and customized life history. System performs psychological profiling for received information using a system of identifiers associated with the person's life and life experiences. Psychological profiling enables discovering issues associated with a person, in addition to predicting issues in the future. Psychological profiling includes a detailed analysis of the persons concerns, morality, ethics, family relationships and other relationships. Non-limiting examples of psychological profiling techniques used by system include Woodworth Personal Data Sheet, Rorschach Inkblot Test, Thematic Apperception Test, Minnesota Multiphasic Personality Inventory, Myers-Briggs Type Indicator, Keirsey Temperment Sorter, 16 PF Questionnaire, Five Factor Personality Inventory, Five Factor Personality Inventory, EQSQ Test, Personal Style Indicator, Strength Deployment Inventory, ProScan Survey, Newcastle Personality Assessor, DISC assessment.

Information associated with a person's life may be provided by another person, for example in case of a deceased person. System provides detailed question and answer query for entry of information. Furthermore, dynamic tagging of information is provided via system.

System supports creation and display of “Avatars”. An Avatar is a graphical representation associated with a person's character. Avatars may provide audio information and facial expressions associated with a person. Pre-recorded audio and video information may be used with the Avatars for creating customized messages for presentation in the future. Responses associated with Avatars may be based upon profile information received and other information provided by user.

System provides the ability to query and receive profile information and other information associated with a person. System provides ability to create customized database and interactive interface. System provides support for creating custom audio and video. As an example, a daughter may visit the model representing the deceased father for interacting with the father. As a non-limiting example, daughter may receive advice from the model of the father. Furthermore, the daughter may graphically interact with the father's model via a number of applications. Furthermore, the daughter may view poems written by the father, view the parent's wedding video, read the father's journal, view the father's thought tags related to marriage and search other marriage related information associated with the father. Furthermore, the daughter may watch a pre-recorded video of the father related to the daughter getting married. The marriage video may be retrieved from a pre-recorded set of videos associated with a variety of life situations. Many years prior to the daughter viewing the information, the father provided information regarding marriage and relationships when performing psychological profiling via the system. This information then enables the system to generate a model of the father and present the model to the daughter.

System uses received, categorized and stored information in addition to artificial intelligence techniques for creating a “life like” model of a person.

The graphical interface associated with the system provides a dynamic chart, graph and/or diagram with symbols for creating a person's “life line”.

Information associated with a person's activities are received, stored and categorized. Non-limiting examples for activities include blogging, journaling and online social networking. Graphical interface may provide a dynamic artistic expression associated with a person's life experiences.

Historical digital information associated with a person may be searched or presented in greater detail via selection of a person's “life line”. A “life line” is a dynamic digital expression associated with a person.

The most recent life experiences and updates associated with a person may be viewed by selecting the most recent portion of a time line. The final life experiences associated with a deceased person may be viewed in addition to events occurring after the death of the person (e.g. funeral, memorial, etc.). Furthermore, associates of a deceased person may continue to add or tag information associated with the deceased person.

An internet website page may be provided such that a user can view information associated with their life experiences page. Furthermore, information provided includes dynamic expressions for a person's life experiences.

System provides categorizing, tagging and labeling combined with life experience organization for presenting a composite of information associated with a person's life.

The information presented via the GUI reflects the ability to of the system to tag and label information. Information may be collected from interaction with the associated person or from other avenues. Non-limiting examples for other avenues of information include digital media, blogs and social networking websites. System operates as master collection point for tagging, labeling and organizing digital information associated with a person's life experiences. Furthermore, system supports processing information for a plurality of persons.

System may be configured for presenting recent information or for presenting information with a specific prior time period or point-in-time. The system enables users to quickly learn about a person from the information presented.

System enables persons to connect with one another via interactive information provided. System may provide information to other networked applications (e.g. family history website).

System enables users to discover and understand information associated with a person's values, likes, dislikes and history. Psychological profiling and pre-recorded video may be used after a person's death, or anytime, for modeling the person and for communicating information in response to queries.

A non-limiting example of a search query provided to system includes “moments I cherished”. Furthermore, in response to receiving the “moments I cherished” query, system provides information associated with moments cherished by the person of interest. Another non-limiting example for a search query provided to system includes “years 1986 to 2006”. Furthermore, in response to receiving the “years 1986 to 2006” query, system provides information for the person of interested associated with the time frame of 1986 to 2006. Another non-limiting example for a search query provided to system includes “something special about my daughter”. Furthermore, in response to receiving the “something special about my daughter” query, special information associated with the daughter may be presented. System may operate to document a person's life experiences, thoughts, values and feelings in order to provide associated information to a multiplicity of applications for further processing and distribution.

System may provide support for a Social Online Network (SON). SON provides a network and interface for providing dynamic life history experience information for users and applications. SON provides privacy and security associated with access to SON. Non-limiting examples of features provided and supported by SON include searching for friends and family, uploading information and media, creating a personal profile, customizing the presentation of information and enabling users to interact with one another. Furthermore, information associated with SON may be tagged or labeled for association with various categories. Furthermore, information associated with SON may be searched by users in order to present information associated with a person's life. SON enables users to connect via their life experiences stored, processed and presented via SON.

System enables support for centers (e.g. building, office, etc.) or “mail in” for receiving, processing and providing information associated with a person's life and for modeling a person's life. Support centers enable the collection of information associated with a person's life. Non-limiting examples of information collected include media and psychological profiling. Furthermore, support centers enable the generation and storage of recorded audio and video for future use. As an example, pre-recorded videos may be used for modeling a person following incapacitation or death. Model of person enables users (e.g. children, family, etc.) to continue to connect and learn about the associated person. Support center supports access to information via SON. Users may learn information about a person via various mediums. Non-limiting examples for mediums include sound bits, videos, thought tags and pre-recorded video messages.

Support centers provide capabilities for capturing audio, video or any medium associated with a person. Furthermore, captured audio and video along with other associated information may be used for creating a media diary for a person. Non-limiting examples of timeframes for collection of information include a person's childhood, teenage and adult years. Furthermore, collected information may be tagged, labeled, processed and organized for viewing and examining a person's life experiences.

Support centers may include memory rooms for providing interaction with the system in order to learn and/or connect with a person no longer living or available for direct contact. Memory rooms provide a private enclosed space for interaction with system. Memory rooms include furniture and décor for support of interaction with the system. Memory rooms include touch screen GUIs with surround sound audio for providing an encompassing experience for a user. A user may view family tree information. Furthermore, a user may view information associated with another person or person's life experiences. As an example scenario, a user may retrieve their family tree, select an individual from the family tree for more detailed information and the view information associated with the selected individual. Non-limiting examples of information viewed include digital media (e.g. photos, videos, etc), audio, high definition pictures. Furthermore, interaction with system may be performed via touch screen interface. Non-limiting examples of information presented include person singing audio, displaying sense of humor and presenting associated moral values. Furthermore, as an example, services provided via memory rooms may also be provided to a user at their home by selecting home experience selection 214.

External services (e.g. specialized family connection websites or niche SONs) may be connected for sending queries and receiving information from system.

As an example of operation, a client subscribes to the system in the year 2015 and dies in the year 2025. In the year 2027, his daughter is considering on marriage but would like to consider the opinion of the father with respect to marriage and relationships. During the father's lifetime, information associated with marriage and relationships provided by the father is stored in the system. As a non-limiting example, videos provided by the father are stored in the system. Using the system, the daughter is able to view a private message from the father directed to the daughter associated with the father's feelings regarding marriage. Furthermore, the daughter performed search queries via the system and viewed information regarding here parent's marriage. Non-limiting examples of information viewed includes photos, videos and poems. As a result of accessing the system, the daughter is able to discern the father's views regarding marriage.

As another example of operation, a user logs into system via system website. User selects and views his/her associated life experiences via their lifeline. The lifeline presents a dynamic model or graph of the person's life experiences. The information present at the end of the graph is presented in real time. For example, if a user uploads a new video to the system, an indication is provided on the lifeline following the successful upload of the video to the system. Non-limiting examples of other information presented via lifeline include Tweets (short text based information messages), blogs, pictures, music, tagged thoughts and shared and tagged information retrieved from the global network. User may configure the system and external entities for providing information from external entities to the system.

Furthermore, user decides to change his associated dynamic life-page lifeline to a different type of interface or app. interface, etc. User then selects to view and then use a “year book” version of the interface illustrating a Life Book with the user's favorite photo or rotating photos.

Furthermore, general users may allowed to add in daily add ins or other items to a Life Page of how he touched people's lives. Or any figure that continues on after death to create change in peoples' lives.

Furthermore, user discovers digital photographs which user decides to upload to the system via the life-page website. The website enables the user to upload the videos to the system and tag/label the photographs. Website interactively interfaces with user for uploading and tagging/labeling the photographs. For example, website may prompt user to provide information associated with the photographs for tagging/labeling. Non-limiting examples of information used for tagging/labeling include date or approximate date photograph created, emotional descriptions (e.g. sad, happy, etc.), relationship (e.g. daughter, son, etc.), description (e.g. summer camp, etc.). Furthermore, information may be provided for tagging/labeling such as “daughter left camp and although I know my daughter is a big girl, I worried my daughter and missed my daughter”. The event is described in detail as a result of the tagging and labeling associated with the provided information. The user may then view the addition of the new information via the person's life-page lifeline or life-book interface. Furthermore, the user may view additional information associated with the event by selecting the presentation of the event via touch screen or via hovering his pointing device (e.g. mouse, finger) over the presentation of the event.

Furthermore, user decides to select to view a lifeline interface. After selecting to view a lifeline interface, user provides a search query of “daughter and happy” and selects to search the years from 2016 to 2020. Furthermore, system aids user in providing queries via prompts and other information assistance mechanisms. Following entry of search query, results of query are presented for viewing to user. Non-limiting examples of information presented include date, year information, photographs, blog articles, journals, thought information and videos associated with the search query tags. User may browse and select items for viewing additional information associated with the items.

Furthermore, user terminates search query with lifeline interface displayed and presenting information associated with person from birth to the present time. User decides to select to view more detailed information for a particular year (e.g. 2018). User selects the year to view in detail and as a result information associated with the selected year is presented for viewing. User may select or hover over the various days presented for the selected year with summary details presented for viewing associated with the selected day. Furthermore, user selects to view in detail a particular day (e.g. Jul. 1, 2018) and as a result information associated with the selected day is presented for viewing. Non-limiting examples of information presented include blog articles, Tweets, social networking activities, pictures and videos. Furthermore, tags/labels associated with the presented information may be displayed and/or shared. User selects an item for detailed viewing. As an example item may be associated with a news article regarding his daughter winning a trophy at a spelling bee.

Furthermore, user may select to view information and information updates associated with friends and family. For example, user may discover that his brother has posted information about the user regarding a particular year (e.g. 2014). User then selects and tags/labels items for association with user's lifeline presentation. User then selects to view the new items provided via his brother and may view his brother's life-book or lifeline interface. As an example, user may view pictures and a video associated with a fishing trip the user and the brother experienced. Furthermore, user may view notes and tags associated with the items provided via his brother. Furthermore, user may add comments to presented items. Furthermore, information provided by the brother may be associated with the user's lifeline for access by the user. User may view comments provided by user and may also view comments provided by others.

Access to the system is controlled via settings and permissions configured by user.

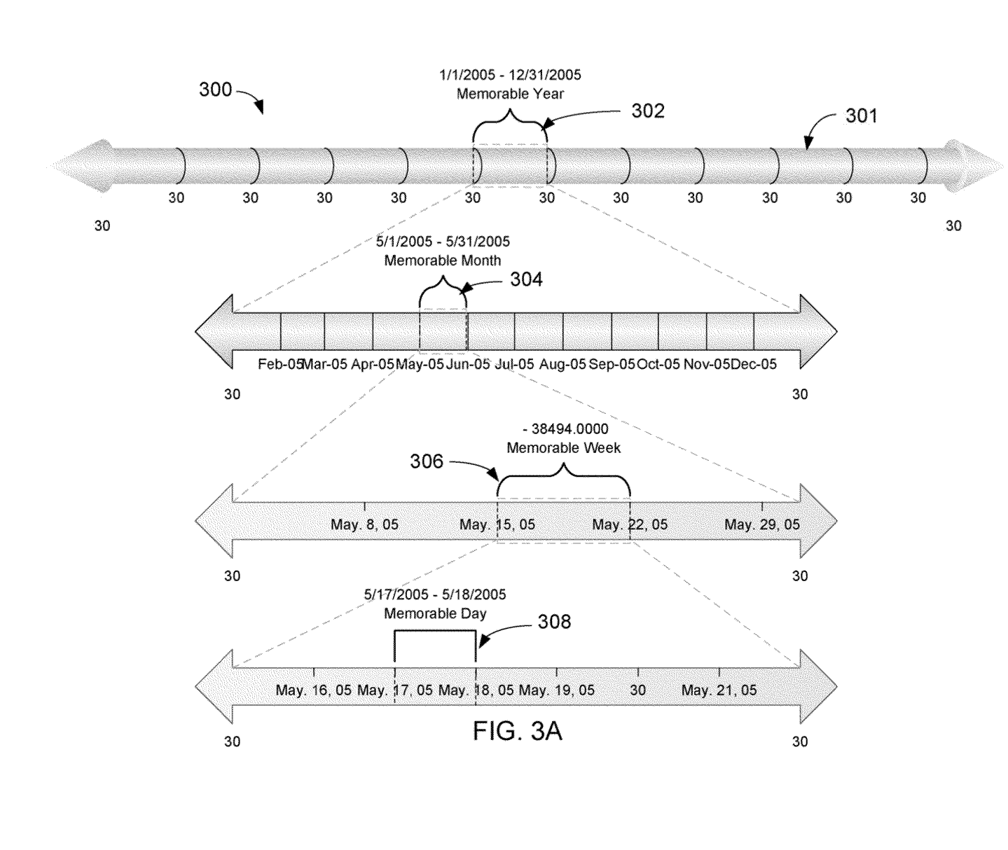

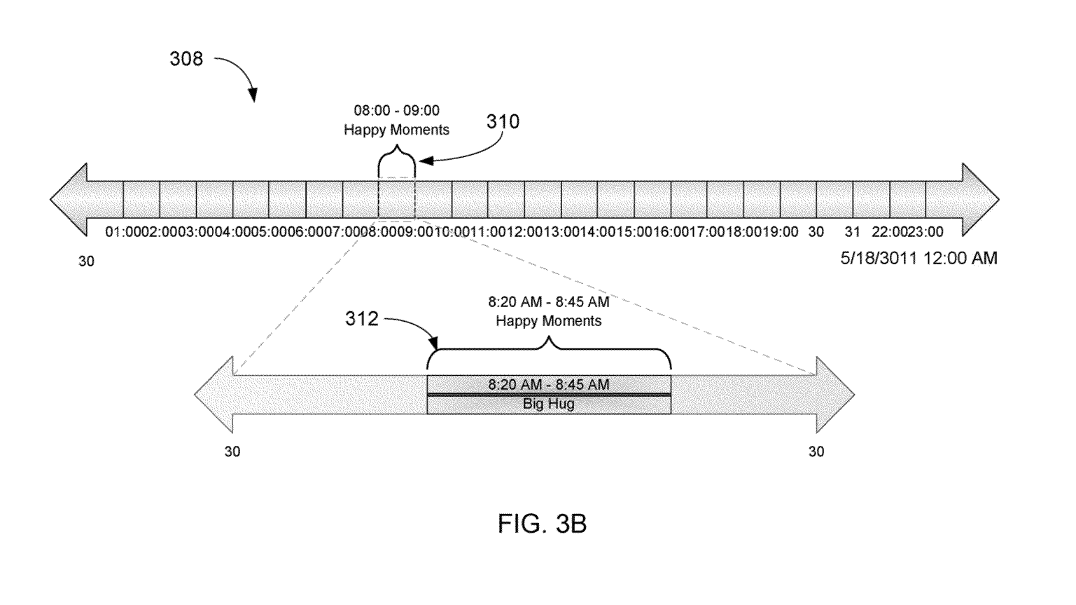

FIG. 3A illustrates an example presentation, in accordance with an embodiment of the present invention.

A presentation 300 includes a decade presentation 301 containing a multiplicity of year presentation with a sampling of year presentation denoted as a year presentation 302.

Year presentation 302 includes a multiplicity of month presentation with a sampling denoted as a month presentation 304.

Month presentation 304 includes a multiplicity of week presentation with a sampling denoted as a week presentation 306.

Week presentation 306 includes a multiplicity of day presentation with a sampling denoted as a day presentation 308.

Discussion with respect to presentation 300 is continued with respect to FIG. 3B.

FIG. 3B continues the illustration of example presentation discussed with reference to FIG. 3A, in accordance with an embodiment of the present invention.

Day presentation 308 includes a multiplicity of time frames with a sampling denoted as a time frame 310.

Time frame 310 includes a happy moment 312. For example, happy moment 312 may be represented by a hug received by a user.

Information associated with presentation 300 may be stored in input vector storage portion 102. Furthermore, information stored may be stored via any known method for storing or tagging the associated information. For example, information may be stored and tagged as happy moments, sad moments, etc.

In operation, a user may seek to perform a search query for an event or events (e.g. happy moments). User performs search and is presented with a presentation of information representing the event or events. User may select to view a particular timeframe of events in more detail (e.g. year, month, day, etc). Furthermore, user may select to view information associated with the event or events in more detail.

FIGS. 3A-B presents an example illustration for selecting to view details associated with a timeline.

FIG. 4 illustrates an example chart, in accordance with an embodiment of the present invention.

A chart 400 includes an x-axis 402, a y-axis 404 a line 406, an event line 408 an event line 410 and an event 412.

The x-axis 402 represents time with units of seconds and the y-axis 404 represents a person's income with units of U.S. dollars.

Line 406 represents a person's income versus time.

Income initiates at an income level 414 at a time t₀. As an example, time t₀ may represent the time at which a person first initiates generating income. Income increases monotonically from time t₀ to time t₁ where income is at an income level 416. As an example, time t₁ may represent the start of a person's first full-time job. Income dramatically increases in value to an income level 418 at a time t₂. As an example, time t₂ may represent a person's receipt of a raise. Income increases monotonically from time t2 to time t3 with income peaking at an income level 420. From time t₃ to time t₄, income decreases monotonically. As an example, time t4 may indicate the initiation of a person's retirement. At a time t₄, income dramatically drops. As an example, time t₄ may represent a person's death at which time income ceases to be realized.

The presentation information associated with FIG. 4 may be stored in input vector storage portion 102 (FIG. 1) with the responses of person 118 (FIG. 1) stored in output vector storage portion 108 (FIG. 1). For example, at time t₂, a person receiving an increase income level may decide to purchase a car. The information associated with purchasing the car is stored in output vector storage portion 108 (FIG. 1). Non-limiting examples of information stored include websites visited and information entered on visited websites. As another example, a person experiencing a decrease in income level, as depicted between time t₃ to time t₄ may decide to downsize to a smaller house with a smaller mortgage payment. The information associated with downsizing to a smaller house is stored in output vector storage portion 108 (FIG. 1). The information associated with chart 400 may be presented to GUI 106 (FIG. 1) for viewing by person 118 (FIG. 1). Furthermore, person 118 (FIG. 1) may add additional information associated with chart 400 for storage and processing by tag processing portion 110.

The income chart described is an example of the capabilities of the system and is not meant to be limiting. By doing psychological profiling, and asking for extensive information on the member, that includes, but not limited to, details of their career choices, income and other such work information, the system may provide the member with detailed analysis of the information requested by generating a chart showing the trend of the specific information. The above example, without limitation, may be done with religion, politics, etc.

FIG. 4 illustrates an example chart where a person's information may be presented.

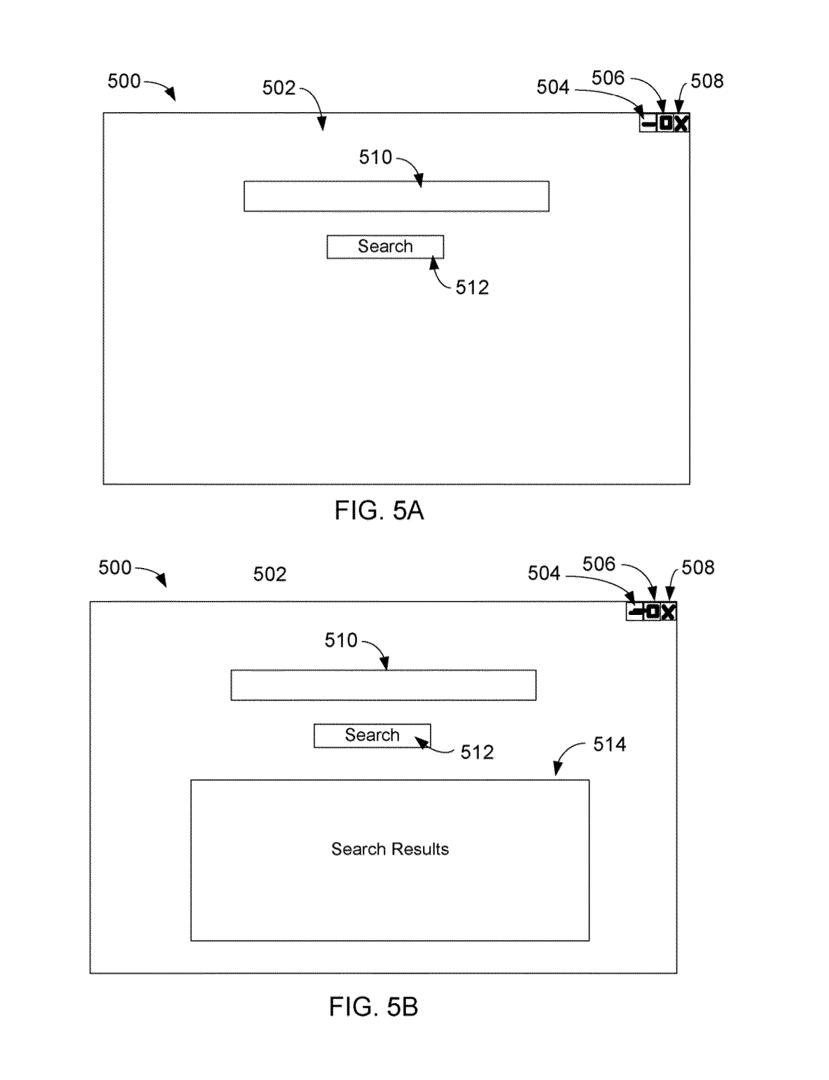

FIG. 5A illustrates an example presentation, in accordance with an embodiment of the present invention.

A presentation 500 includes a presentation area 502, a minimize button 504, a maximize button 506, a close button 508, a textual input box 510 and a selection button 512.

Presentation 500 presents and receives information associated with searching information associated with a person. For example, person 118 (FIG. 1) may be presented with presentation 500 via GUI 106 (FIG. 1).

Minimize button 504 enables minimization of presentation 500. For example selecting minimize button 504 removes presentation 500 from being displayed via GUI 106 (FIG. 1), yet presentation 500 remains alive for later reactivation.

Maximize button 506 enables maximization of presentation 500. For example, selecting maximize button 506 enables the display of presentation 500 to occupy the display area associated with GUI 106 (FIG. 1).

Close button 508 enables termination of display of presentation 500. For example, selecting close button 508 enables closing presentation 500 from being presented via GUI 106 (FIG. 1).

Textual input box 510 receives information associated with searching for information. For example, a person searching for the type of shoes a person wore may enter “shoes” into textual input box 510 in order to determine the type of shoes a person wore.

Selection button 512 enables a search query to be performed. For example, after entering information to be searched in textual input box 510, a person may activate selection button 512 in order to initiate a search.

FIG. 5B illustrates an example presentation following execution of a search query, in accordance with an embodiment of the present invention.

A search results presentation 514 presents the results of a performed search query. Non-limiting examples of information presented via search results presentation 514 include text, audio, video, pictures, tags, labels, graphs, charts and Avatars. For this example, an Avatar may be presented as a three dimensional graphical representation of a person. In operation, following entry of textual information associated with a query into textual input box 510 and following activation of selection button 512, information retrieved as a result of the search query may be presented via search results presentation 514. For example, a query for “shoes” might return the brands, colors and sizes for the shoes a person wore.

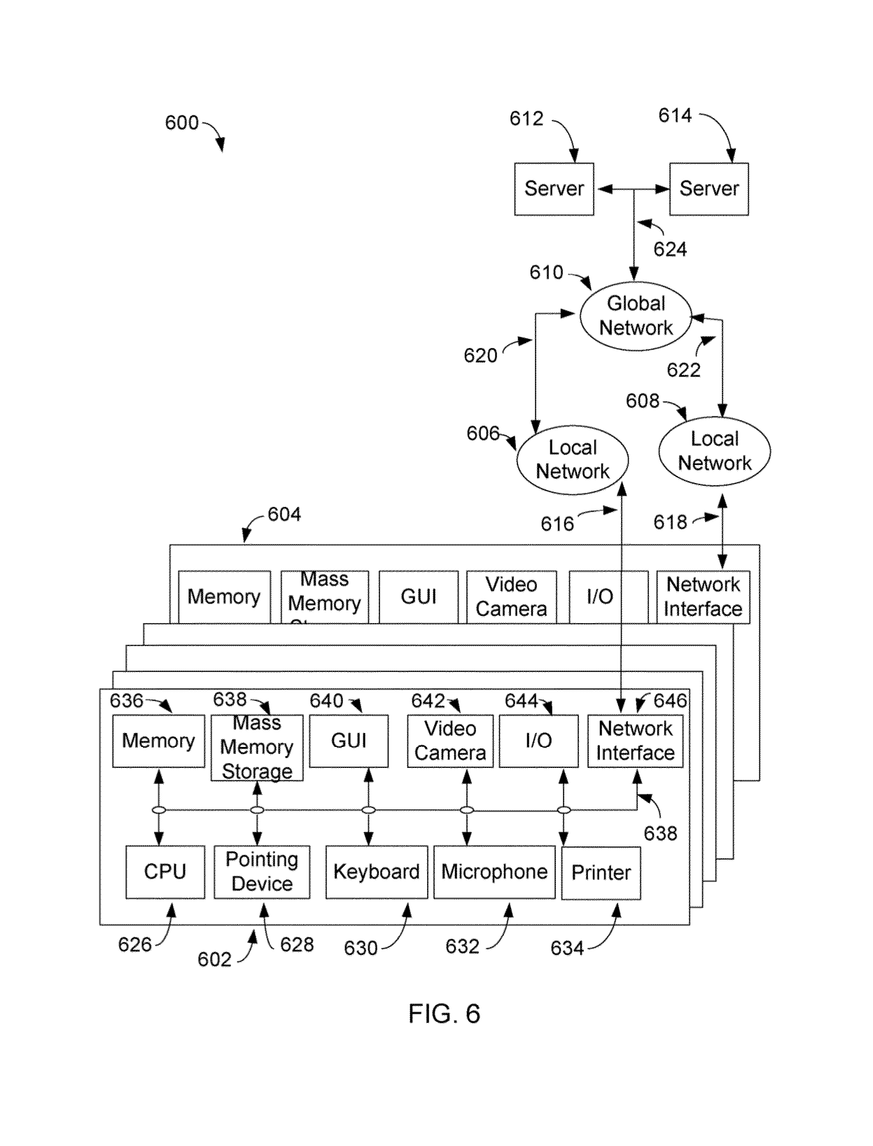

FIG. 6 is a block diagram depicting an exemplary client/server system which may be used by an exemplary web-enabled/networked embodiment of the present invention.

A communication system 600 includes a multiplicity of clients with a sampling of clients denoted as a client 602 and a client 604, a multiplicity of local networks with a sampling of networks denoted as a local network 606 and a local network 608, a global network 610 and a multiplicity of servers with a sampling of servers denoted as a server 612 and a server 614.

Client 602 may communicate bi-directionally with local network 606 via a communication channel 616. Client 604 may communicate bi-directionally with local network 608 via a communication channel 618. Local network 606 may communicate bi-directionally with global network 610 via a communication channel 620. Local network 608 may communicate bi-directionally with global network 610 via a communication channel 622. Global network 610 may communicate bi-directionally with server 612 and server 614 via a communication channel 624. Server 612 and server 614 may communicate bi-directionally via communication channel 624. Furthermore, clients 602, 604, local networks 606, 608, global network 610 and servers 612, 614 may communicate bi-directionally.

In one embodiment, global network 610 may operate as the Internet. It will be understood by those skilled in the art that communication system 600 may take many different forms. Non-limiting examples of forms for communication system 600 include local area networks (LANs), wide area networks (WANs), wired telephone networks, wireless networks, or any other network supporting data communication between respective entities.

Clients 602 and 604 may take many different forms. Non-limiting examples of clients 602 and 604 include personal computers, personal digital assistants (PDAs), cellular phones and smartphones.

Client 602 includes a CPU 626, a pointing device 628, a keyboard 630, a microphone 632, a printer 634, a memory 636, a mass memory storage 638, a GUI 640, a video camera 642, an input/output interface 644 and a network interface 646.

CPU 626, pointing device 628, keyboard 630, microphone 632, printer 634, memory 636, mass memory storage 638, GUI 640, video camera 642, input/output interface 644 and network interface 646 may communicate in a unidirectional manner or a bi-directional manner via a communication channel 648. Communication channel 648 may be configured as a single communication channel or a multiplicity of communication channels.

CPU 626 may be comprised of a single processor or multiple processors. CPU 626 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 636 is used typically to transfer data and instructions to CPU 626 in a bi-directional manner. Memory 636, as discussed previously, may include any suitable computer-readable media, intended for data storage, such as those described above excluding any wired or wireless transmissions unless specifically noted. Mass memory storage 638 may also be coupled bi-directionally to CPU 626 and provides additional data storage capacity and may include any of the computer-readable media described above. Mass memory storage 638 may be used to store programs, data and the like and is typically a secondary storage medium such as a hard disk. It will be appreciated that the information retained within mass memory storage 638, may, in appropriate cases, be incorporated in standard fashion as part of memory 636 as virtual memory.

CPU 626 may be coupled to GUI 640. GUI 640 enables a user to view the operation of computer operating system and software. CPU 626 may be coupled to pointing device 628. Non-limiting examples of pointing device 628 include computer mouse, trackball and touchpad. Pointing device 628 enables a user with the capability to maneuver a computer cursor about the viewing area of GUI 640 and select areas or features in the viewing area of GUI 640. CPU 626 may be coupled to keyboard 630. Keyboard 630 enables a user with the capability to input alphanumeric textual information to CPU 626. CPU 626 may be coupled to microphone 632. Microphone 632 enables audio produced by a user to be recorded, processed and communicated by CPU 626. CPU 626 may be connected to printer 634. Printer 634 enables a user with the capability to print information to a sheet of paper. CPU 626 may be connected to video camera 642. Video camera 642 enables video produced or captured by user to be recorded, processed and communicated by CPU 626.

CPU 626 may also be coupled to input/output interface 644 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 626 optionally may be coupled to network interface 646 which enables communication with an external device such as a database or a computer or telecommunications or internet network using an external connection shown generally as communication channel 616, which may be implemented as a hardwired or wireless communications link using suitable conventional technologies. With such a connection, CPU 626 might receive information from the network, or might output information to a network in the course of performing the method steps described in the teachings of the present invention.

FIG. 6 is a block diagram depicting an exemplary client/server system.

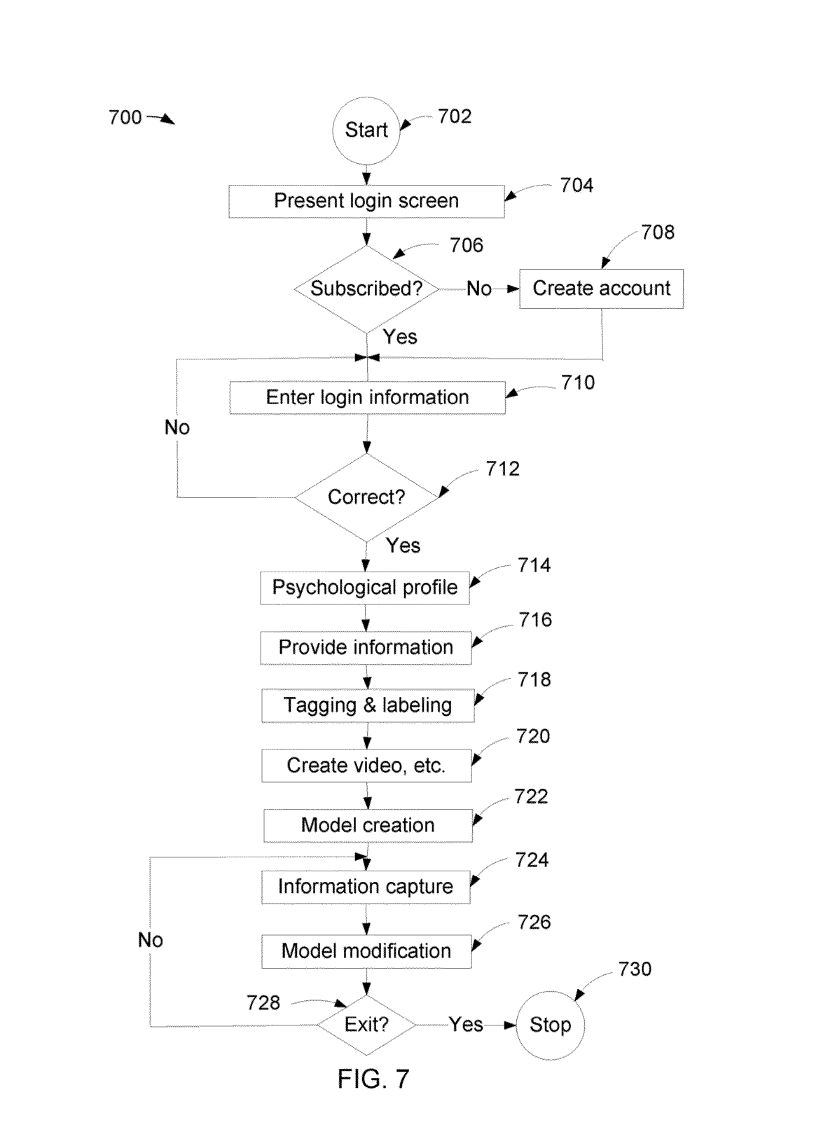

FIG. 7 illustrates an example method for account setup and configuration, in accordance with an embodiment of the present invention.

A flow chart 700 initiates in a step 702.

In a step 704, a user may be presented with a login screen for entering account information or for creating an account via a GUI (e.g. GUI 106 (FIG. 1)).

A determination for subscription may be performed in a step 706.

For a determination of not having a subscription in step 706, in a step 708 user may create an account.

For a determination of having a subscription in step 706, in a step 710, user may enter account information.

A determination for entering correct account information may be performed in a step 712.

For a determination of incorrect account information in step 712, execution of the method transitions to step 710, where a user may reenter account information.

For a determination of correct information in step 712, in a step 714, user may enter information associated with creating a psychological profile.

A person (e.g. person 118 (FIG. 1)) receives information requesting psychological profiling information via a GUI (e.g. GUI 106 (FIG. 1)). Furthermore, person's responses to psychological profile are stored in input vector storage (e.g. input vector storage portion 102 (FIG. 1)) and output vector storage (e.g. output vector storage portion 108 (FIG. 1)).

In a step 716, user may provide information to system. Non-limiting exampled of information include videos, pictures, notes, journals and news clippings.

As an example, user may enter audio/video via audio/video capture devices (e.g. audio/video portion 104 (FIG. 1)).

In a step 718, user may tag or label information provided in step 716.

As an example, a user may select to tag a photograph as “happy”. Furthermore, the information associated with the photograph and its associated tag or label may be stored and processed (e.g. tag processing portion 110 (FIG. 1)).

In a step 720, user may create audio, video, etc. Audio, video, etc. may be presented to other user and/or may be used for creating a model of the user.

In a step 722, a model of the user is created.

Processing is performed using input vectors (e.g. input vector storage portion 102 (FIG. 1)), output vectors (e.g. output vector storage portion 108 (FIG. 1)), tag/labels (e.g. tag processing portion 110 (FIG. 1)) and audio/video (e.g. audio/video portion 104 (FIG. 1)) for creating a model (e.g. model portion 116 (FIG. 1) of a person.

The accuracy of the model may be tested by applying input vectors to the model (e.g. model portion 116 (FIG. 1) and comparing (e.g. compare portion 112 (FIG. 1)) the actual results with the results of the model.

In a step 724, information associated with the user is captured. Non-limiting examples for capturing information include keystrokes, websites visited, emails transmitted and interaction with social networks.

User experiences input stimuli (e.g. stimuli portion 120 (FIG. 1)) and generates a response (e.g. response portion 124 (FIG. 1)). The input stimuli are stored as input vectors (e.g. input vector storage portion 102 (FIG. 1) and the output responses are stored as output vectors (e.g. output vector storage portion 108 (FIG. 1)).

In a step 726, the model of the user is modified based upon new information received.

As new stimuli is received (e.g. stimuli portion 120 (FIG. 1)) is processed for generating a revised model of the person (e.g. model portion 116 (FIG. 1)).

A determination for exiting the method is performed in a step 728.

For a determination of not exiting the method, execution of the method transitions to step 724.

For a determination of exiting the method, execution of the method terminates in a step 730.

FIG. 7 illustrates a method for access, initializing and interacting with the system.

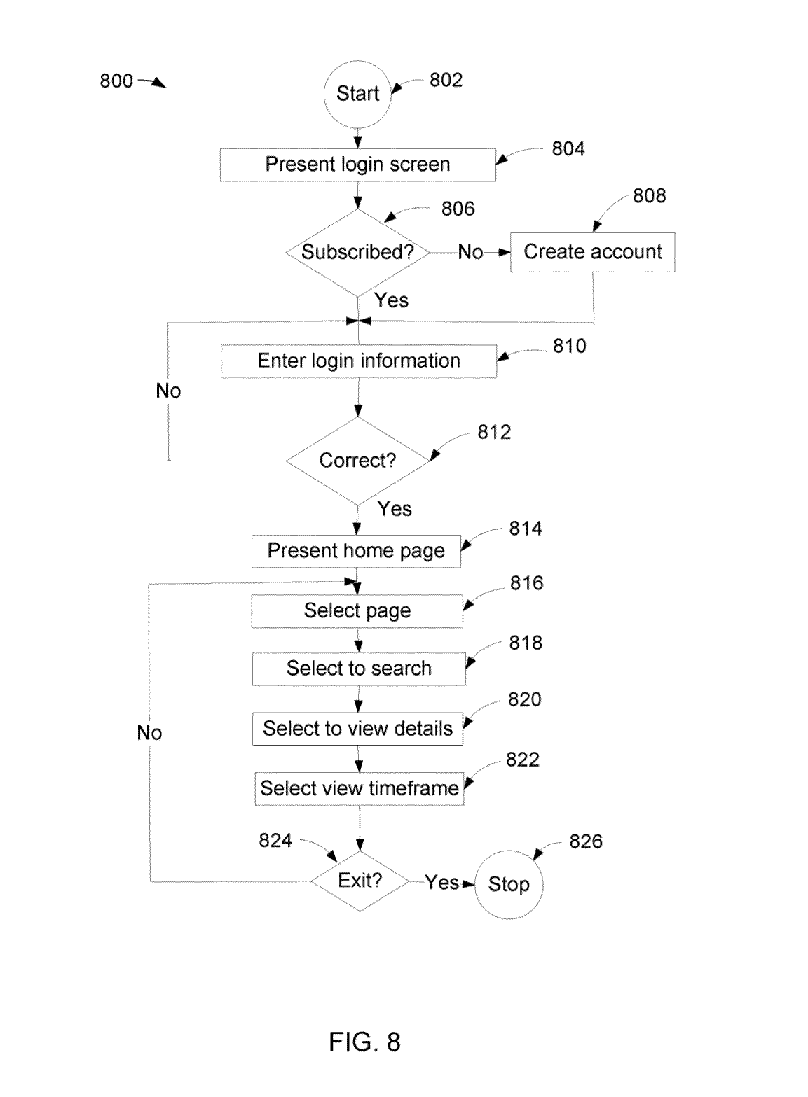

FIG. 8 illustrates an example method for account setup and configuration, in accordance with an embodiment of the present invention.

A flow chart 800 initiates in a step 802.

In a step 804, a user may be presented with a login screen for entering account information or for creating an account via a GUI (e.g. GUI 640 (FIG. 6)).

A determination for subscription may be performed in a step 806.

For a determination of not having a subscription in step 806, in a step 808 user may create an account.

For a determination of having a subscription in step 806, in a step 810, user may enter account information.

A determination for entering correct account information may be performed in a step 812.

For a determination of incorrect account information in step 812, execution of the method transitions to step 810, where a user may reenter account information.

For a determination of correct information in step 812, in a step 814, user may be presented a home page (e.g. presentation 200 (FIG. 2)).

In a step 816, a user may select a page for viewing (e.g. life page selection 210 (FIG. 2), memory room selection 212 (FIG. 2) and home experience selection 214 (FIG. 2)).

In a step 818 a user may select to search for life experience information using a search interface (e.g. presentation 500 (FIG. 5)).

In a step 820, a user may select to view details associated with life experience information (e.g. chart 400 (FIG. 4)).

In a step 822, a user may select to view a timeframe via a timeline (e.g. month presentation 304 (FIG. 3A) or happy moment 312 (FIG. 3B)).

A determination for exiting the method is performed in a step 824.

For a determination of not exiting the method, execution of the method transitions to step 816.

For a determination of exiting the method, execution of the method terminates in a step 826.

FIG. 8 illustrates a method for accessing and interacting with the system.

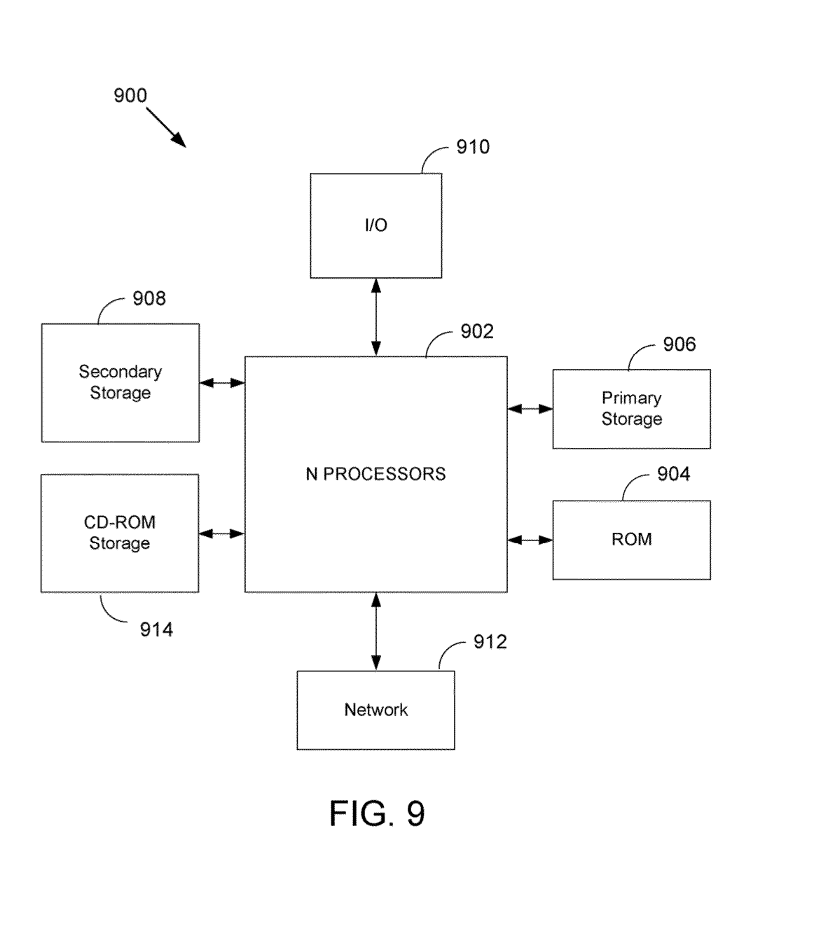

FIG. 9 illustrates a computing system that, when appropriately configured or designed, may serve as a computing system for which the present invention may be embodied.

A computing system 900 includes a quantity of processors 902 (also referred to as central processing units, or CPUs) that may be coupled to storage devices including a primary storage 906 (typically a random access memory, or RAM), a primary storage 904 (typically a read only memory, or ROM). CPU 902 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 904 acts to transfer data and instructions uni-directionally to the CPU and primary storage 906 is used typically to transfer data and instructions in a bi-directional manner. The primary storage devices discussed previously may include any suitable computer-readable media such as those described above. A mass storage device 908 may also be coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within mass storage device 908, may, in appropriate cases, be incorporated in standard fashion as part of primary storage 906 as virtual memory. A specific mass storage device such as a CD-ROM 914 may also pass data uni-directionally to the CPU.

CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications or internet network using an external connection shown generally as a network 912, which may be implemented as a hardwired or wireless communications link using suitable conventional technologies. With such a connection, the CPU might receive information from the network, or might output information to the network in the course of performing the method steps described in the teachings of the present invention.

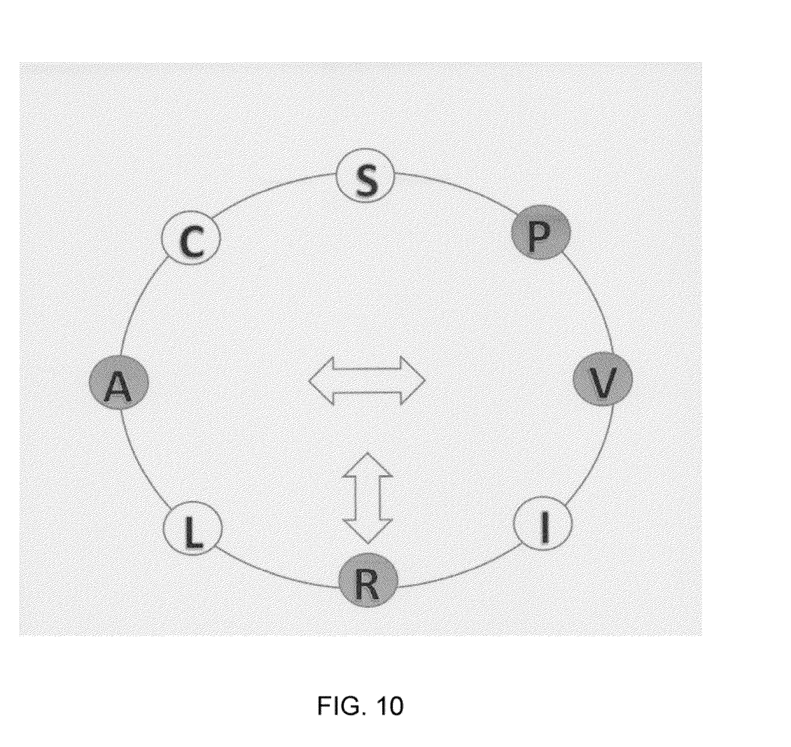

FIG. 10 illustrates an example interface for a mobile device, in accordance with an embodiment of the present invention. The Life Page Looking Glass Interface shown may allow users to readily access Life Page assets on a mobile device such as, but not limited to, a smart phone or tablet with a touch screen. The user may access the various area of Life Page assets by tapping the corresponding Life node, lettered S, P, V, I, R, L, A, C.

S—The Settings Node contains various settings accessible by horizontal navigation.
P—The Photos Node contains photos.
V—The Videos Node contains video.
I—The Info Node contains the Contact Info in clickable form.
R—The Resume Node contains an interactive resume.
L—The Look Node contains the list of linked lookers with access to a users Life Page.
A—The AVATAR Node contains the AVATAR.
C—The Communicate/Capture Node allows users to communicate with other users and capture pictures or video to be added to their timeline.

Life Nodes may highlight when information is available. Once a Life Node is selected the Life Page the Life Page Looking Glass will disappear and the assets for that Life Node may be displayed. When the Life Page Looking Glass is displayed, the date of the assets may appear. To jump to a forward date containing assets, the user may swipe up. To jump to a backward date containing assets, the user may swipe down. The user may limit the Look Window on a Settings Screen such that only assets within a particular range of dates may appear. The user may specify search filter criteria on a Settings Screen such that only assets matching key terms may appear. The various node areas may contain controls necessary for their functionality such as, but not limited to, the Video Node may contain play, forward, back, pause and other necessary controls.

A system has been presented which provides the capability for retrieving and processing information associated with life experiences. System provides capability to receive and process stimuli and responses in order to create a model of a person. The created model of the person provides capability to present a representation of a person's responses with regard to receiving stimuli. System provides capability for viewing and interacting with information associated with a person's life experiences.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global networking components.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods for a life experiences system according to the present invention will be apparent to those skilled in the art. The invention has been described above by way of illustration, and the specific embodiments disclosed are not intended to limit the invention to the particular forms disclosed. For example, the particular implementation of the GUIs may vary depending upon the particular type computing device used. The system described in the foregoing were directed to notebook computer implementations; however, similar techniques using mobile computing implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A non-transitory computer-readable storage medium with an executable program stored thereon, wherein the program instructs a processor to perform the following steps:
registering as a member of a life experience system;
receiving a home page from the life experience system;
submitting psychological profiling information to the life experience system, in which the life experience system stores said psychological profiling information and generates a psychological profile;
submitting life experience information to the life experience system, said life experience information comprising at least text and pictures relating to life experiences of the member, in which the life experience system stores said life experience information;
tagging items of said life experience information, said tags at least comprising date information and the members comments and emotions in which the life experience system stores tags with said life experience information and processes at least said psychological profiling information, life experience information and said tags to update said psychological profile of the member, the life experience system further organizing said life experience information in a timeline; and
receiving an updated home page from the life experience system in which said timeline and said life experience information are accessible.

2. The program instructing the processor as recited in claim 1, further comprising the step of receiving guidance, at least in part based on said psychological profile, from the life experience system during said tagging.

3. The program instructing the processor as recited in claim 1, further comprising the step of receiving guidance, at least in part based on said psychological profile, from the life experience system for submitting additional life experience information.

4. The program instructing the processor as recited in claim 1, further comprising the step of submitting additional life experience information to the life experience system, said additional life experience information comprising at least video and audio information in which the life experience system generates a life video at least in part based on said psychological profile.

5. The program instructing the processor as recited in claim 4, further comprising the step of receiving an updated home page from the life experience system in which said life video is accessible.

6. The program instructing the processor as recited in claim 1, further comprising the step of submitting a query to the life experience system in which said query at least comprises a search for an emotion.

7. The program instructing the processor as recited in claim 1, further comprising the step of submitting a query to the life experience system in which said query at least comprises a search for a time frame.

8. The program instructing the processor as recited in claim 1, further comprising the step of receiving guidance, at least in part based on said psychological profile, from the life experience system for personalizing said home page.

9. The program instructing the processor as recited in claim 1, further comprising the step of selecting items from said life experience information to be grouped in a selection accessible from said home page.

10. The program instructing the processor as recited in claim 1, further comprising the step of receiving recommendations, at least in part based on said psychological profile, from the life experience system for meeting other members.

11. A computer-implemented system comprising:
means being configured for receiving psychological profiling information, life experience information and tags at least comprising date information, comments and emotions for said life experience information from registered members of a life experience system, said receiving means being further configured for processing said psychological profiling information, life experience information and tags to generate a psychological profile of the member and a timeline of said life experience information; and
means being configured for submitting said psychological profiling information, life experience information and tags to said receiving means, said submitting means being further configured for receiving from said receiving means a home page in which said time line and said life experience information is accessible.

12. A computer-implemented system comprising:
a server executing a computer-executable program being configured for receiving psychological profiling information, life experience information and tags at least comprising date information, comments and emotions for said life experience information from registered members of a life experience system, said server being further configured for processing said psychological profiling information, life experience information and tags to generate a psychological profile of the member and a timeline of said life experience information; and
a client executing a computer-executable application being configured for submitting said psychological profiling information, life experience information and tags to said server, said client being further configured for receiving from said server a home page in which said time line and said life experience information is accessible.

13. The computer-implemented system as recited in claim 12, in which said client is further configured for receiving guidance, at least in part based on said psychological profile, from server during submission of said tags.

14. The computer-implemented system as recited in claim 12, in which said client is further configured for receiving guidance, at least in part based on said psychological profile, from said server for submitting additional life experience information.

15. The computer-implemented system as recited in claim 12, in which said client is further configured for submitting additional life experience information to said server, said additional life experience information comprising at least video and audio information in which said server generates a life video at least in part based on said psychological profile.

16. The computer-implemented system as recited in claim 15, in which said client is further configured for receiving an updated home page from said server in which said life video is accessible.

17. The computer-implemented system as recited in claim 12, in which said client is further configured for submitting a query to said server in which said query at least comprises a search for an emotion.

18. The computer-implemented system as recited in claim 12, in which said client is further configured for submitting a query to said server in which said query at least comprises a search for a time frame.

19. The computer-implemented system as recited in claim 12, in which said client is further configured for receiving guidance, at least in part based on said psychological profile, from said server for personalizing said home page.

20. The computer-implemented system as recited in claim 12, in which said client is further configured for selecting items from said life experience information to be grouped in a selection accessible from said home page.
